(19) United States
(12) Patent Application Publication
(10) Pub. No.: US 2020/0325924 A1
(43) Pub. Date: Oct. 15, 2020

(54) CAST-IN PLACE ANCHOR WITH MULTI-USE JAWS AND REMOVABLE NOSE-PIECE

(71) Applicant: BLACK & DECKER INC., New Britain, CT (US)

(72) Inventors: Mark J. SEROKOSZ, New Fairfield, CT (US); Kyle CHRISTOPHERSEN, Lutherville-Timonium, MD (US); Jack DUNNING, White Plains, NY (US)

(21) Appl. No.: 16/794,332

(22) Filed: Feb. 19, 2020

Related U.S. Application Data
(60) Provisional application No. 62/833,029, filed on Apr. 12, 2019.

(51) Int. Cl. F16B 13/12; F16B 37/08; F16B 13/08

(52) U.S. Cl. CPC F16B 13/128; F16B 13/124; F16M 13/02; F16B 13/0866; F16B 37/0857

(57) ABSTRACT

An anchor system is disclosed for anchoring objects to a concrete structure after concrete setting. The assembly includes an anchor housing having a threaded opening, a metal decking anchor assembly and a wood form anchor assembly. The wood form and the metal decking anchor assemblies may accommodate the anchor housing and the anchor housing is used in one of the wood form anchor assembly and the metal decking anchor assembly. The metal decking anchor assembly includes a nose-piece and the anchor housing is selectively connectable to the nose-piece via a locking connection such as a bayonet connection.

### CROSS-REFERENCE TO RELATED APPLICATIONS

This application claims priority from U.S. Provisional Application No. 62/833,029, filed Apr. 12, 2019, the disclosure of which is incorporated herein by reference in its entirety.

### FIELD

This specification relates to a cast-in-place anchor assembly for suspending objects below a metal deck after concrete pouring and concrete setting.

### BACKGROUND

The WoodKnocker® and Bang-It+products are cast-in-place anchor assemblies available for purchase and aspects of the present invention are conceived to improve upon this product. In the recent past Applicant has filed patent applications with subject matter generally related to the present application. U.S. patent application Ser. No. 16/002,099, filed Jun. 7, 2018, and entitled Cast-In Place Anchor Assembly covers a cast-in place anchor the disclosure of which is incorporated herein by reference in its entirety. In addition, U.S. patent application Ser. No. 15/923,052, filed on Mar. 16, 2018, and entitled Snap Nut Concrete Anchor Assembly also covers a cast-in-place-anchor the disclosure of which is incorporated herein by reference. Furthermore, U.S. patent application Ser. No. 15/948,131, filed on Apr. 9, 2018, and entitled Snap Nut Concrete Anchor Assembly also covers a cast-in-place-anchor the disclosure of which is incorporated herein by reference.

There are at least two conventional types of cast-in-place anchors. A first type secures a cast-in-place anchor in position adjacent to a wooden concrete forming boundary and a second type secures a cast-in-place anchor in position adjacent to metal decking. After concrete pouring and setting each type of cast-in-place anchor provides an anchoring point to which an object (e.g., a threaded rod) can be anchored. Both types of anchor include a jaw assembly arranged in an anchor housing. Load applied to the threaded rod is transferred to threaded jaws of the jaw assembly which in turn transfer load to the anchor housing. The anchor housing includes a flange which is ultimately embedder in the cured concrete and which transfers load from the anchor housing to the cured concrete. It would be beneficial to develop an anchor system in which a single anchor housing may be usable in both of the two types of cast-in-place previously discussed and a user may choose to use that single anchor housing in one or the other of the types to form a cast-in-place anchor. Such a dual use anchor housing would save money by preventing a supplier from having to make different anchor housing designs for each type of cast-in-place anchor.

In conventional cast-in-place anchors for providing an anchoring point adjacent to metal decking, a nose-piece of the anchor is inserted through an opening in the metal decking. When the metal decking is a support in a multi-story building for a new floor slab, after setting, the nose-piece extends below the decking. That means access can be gained to the nose-piece from the floor below. From the floor below, an anchor member (e.g., a threaded rod) may be inserted through the nose-piece and further into the anchor housing to the jaw assembly. The jaw assembly engages the anchor member to secure the anchor member to the anchor and to the slab. In a seismic event, the slab may be thrust up and down which could reverse the normal downward intended gravity load into an upward load. In this reverse load mode and in some cast-in-place designs, the jaw assembly may move upward under that reverse upward load and then down again. Also, if the jaw assembly design is one of a split nut design, the dynamic movement of the jaws relative to the anchor housing could cause the threaded jaws to separate and lose hold of the threaded rod. One solution to preventing the jaws from moving upward relative to the anchor housing is to include a washer and a nut on the threaded rod so that the washer is adjacent the lower surface of the metal decking and the nut is threaded on the rod adjacent to the washer. Therefore, any upward load from the threaded rod gets transferred to the nut then to the washer and then to the metal decking and cured concrete slab. To be able to install the washer, it would be beneficial to have a removeable nose-piece as a conventional nose-piece would occupy at least a portion of the space where the washer and nut would be installed.

### SUMMARY

According to an aspect of the present invention there is provided a cast-in-place anchor assembly for anchoring objects to a concrete structure after concrete setting. The anchor assembly includes an anchor housing. The anchor housing includes an opening therein along a longitudinal axis thereof for receiving an elongate load bearing member or anchor member. The anchor housing also includes a jaw assembly for lockingly engaging and axially securing or restricting the anchor member relative to the anchor housing. Furthermore, the assembly includes an anchor body. The anchor body includes a bias member, a plate, and a nose-piece. The nose-piece includes an anchor connector for connecting to a nose connector of the anchor housing.

### BRIEF DESCRIPTION OF THE DRAWINGS

Embodiments will now be described by way of non-limiting example with reference to the accompanying drawings in which:

FIG. 1 is a side view of a metal decking anchor assembly of the present invention anchor system;

FIG. 1B is an exploded top perspective view of the metal decking anchor of FIG. 1.

FIG. 2A is a side cross-sectional view of a wood form anchor assembly of the present invention anchor system in a pre-install configuration;

FIG. 2B is a side cross-sectional view of a wood form anchor assembly of the present invention anchor system in a post-install configuration.

FIG. 2C is an exploded top perspective view of the wood form anchor assembly of the present invention anchor system;

FIG. 3A1 discloses a bottom perspective view of an anchor housing for use with either of the anchor assemblies of FIGS. 1A, 1B or FIGS. 2A, 2B, 2c.

FIG. 3A2 discloses a side perspective view of an anchor housing for use with either of the anchor assemblies of FIGS. 1A, 1B or FIGS. 2A, 2B, 2c of the present invention anchor system.

FIG. 3B shows a cross-sectional view of a nose piece of the anchor assembly of FIG. 1

FIG. 3C shows a cross-sectional view of a connection between the anchor housing and the nose-piece of the anchor assembly of FIG. 1.

FIG. 4A shows a cross sectional view of the anchor assembly of FIG. 1.

FIG. 4B shows a side view of the anchor assembly as shown in FIG. 1 in an installed configuration.

FIG. 5 shows a bottom perspective view of an installed anchor assembly of FIG. 1 with the nose-piece removed.

### DETAILED DESCRIPTION

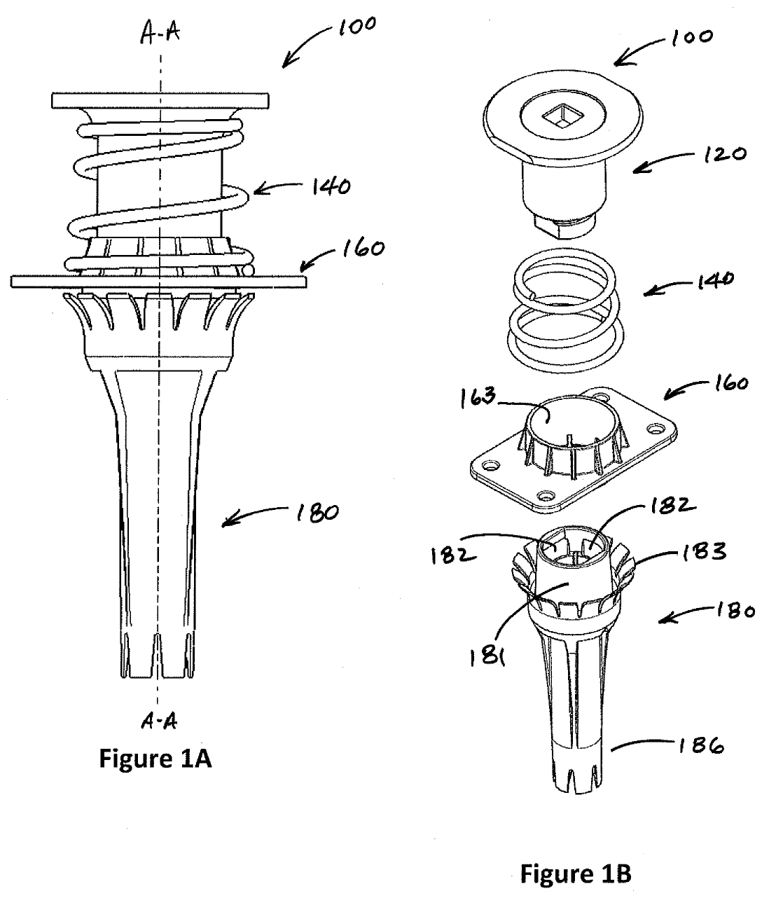

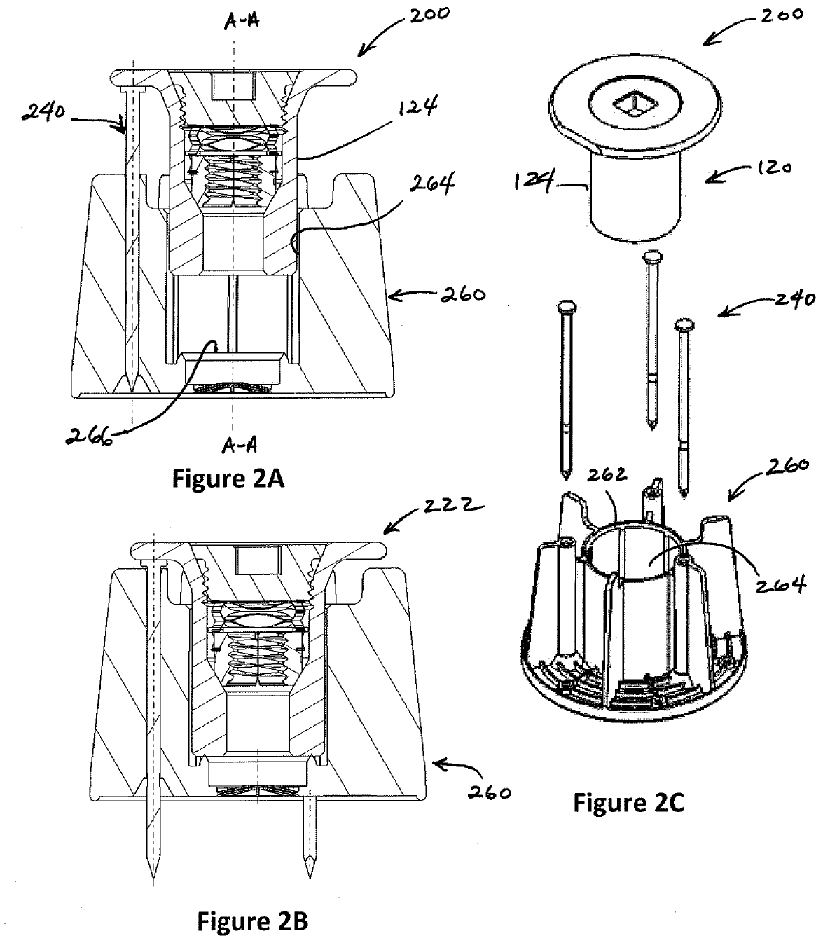

FIGS. 1A and 1B show a cast-in-place metal deck anchor assembly 100 for suspending objects below a metal deck after concrete is poured onto the metal deck. Metal decking anchor assembly 100 includes an anchor housing 120, a spring 140, a plate 160 and a nose-piece 180. FIGS. 2A, 2B and 2C show a cast-in-place wood form anchor assembly 200 for anchoring objects to a concrete structure after concrete pouring. Wood form anchor assembly 200 includes an anchor housing 220 (which in some cases is identical and interchangeable with anchor housing 220 of assembly 100), wood fastening members 240 (e.g., nails), and a base housing 260.

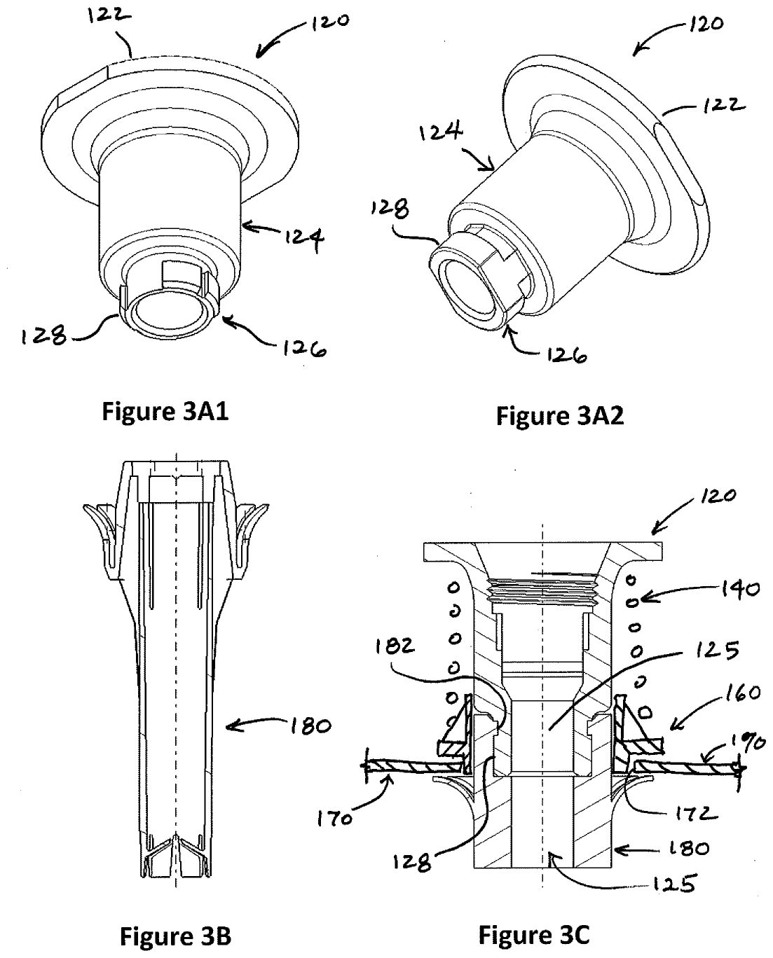

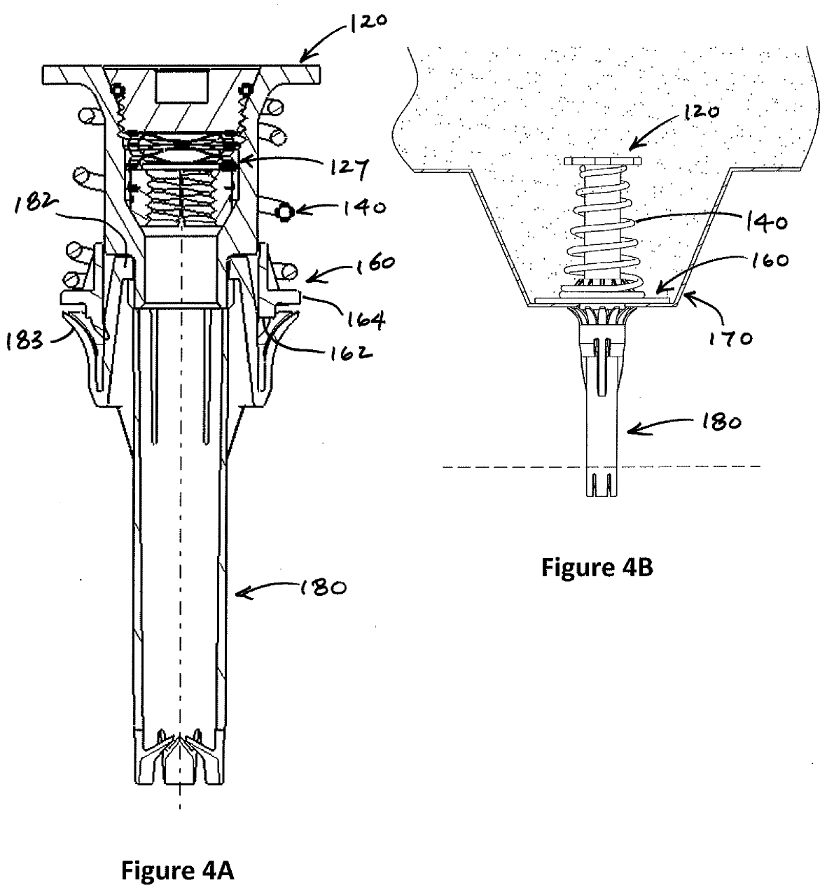

As shown in FIGS. 3A1, 3A2, 3B, and 3C, anchor housing 120 has a head portion 122 and a shank portion 124 and may be made of metal or other suitable material. Shank portion 124 further includes a nose connector 126 at an end opposite the flange or head portion 122. Nose connector 126 may include a locking structure 128 comprised of projections and/or recesses. Anchor assembly 120 also has a central longitudinal passage along a central axis A-A. Shank portion 124 may house a jaw assembly 127 (see FIG. 4A). Jaw assembly 127 may comprise a fixed threaded bore or may include a threaded bore formed from biased internally threaded split nuts. The central longitudinal passage passes through jaw assembly 127.

Nose-piece 180 of metal decking assembly 100 may be elongate and may include a central passage along axis A-A. An upper or first end 181 of nose-piece 180 includes an anchor connector 182 for connecting nose-piece 180 with anchor housing 120. Specifically, anchor connector 182 engages nose connector 126 to secure anchor housing 120 to nose-piece 180. Anchor connector 182 and nose-connector 126 may include projections and recesses that support a bayonet connection therebetween. Such a bayonet connection allows anchor housing 120 to be fit axially together with nose-piece 180 and then rotated into a position such that the two pieces are relatively locked together. Removal of the nose-piece from the anchor housing may include a reverse process of rotating nose-piece 180 relative to anchor housing 120 and then axially separating the pieces. As an alternative to a bayonet connection, nose connector 126 and anchor connector 182 may be a simple threaded or friction connection. The friction connection may rely on complementary tapered surface that securely engage each other via relative axial and/or torsional forces applied to anchor housing 120 and nose-piece 180. Nose-piece 180 also includes flexible stoppers 183. Flexible stoppers 183 extend radially outward so as to extend to or form a radius that is greater than the radius of the opening in the metal decking into which assembly 100 is to be installed.

Plate 160 may be a flat member with a central opening 163. When fully assembled, central opening 163 is disposed around an outer wall of shank portion 124 of anchor housing 120. Plate 160 is positioned between flexible stoppers 183 of nose-piece 180 and head 122 of anchor housing 120. Opening 162 may be slightly larger than an outer wall of shank portion 124 so that plate 160 is free to move axially between head 122 and flexible stoppers 183. A spring or bias member 140 is disposed between a top surface of plate 160 and a bottom surface of flange or head 122. Specifically, plate 160 may move axially along shank portion 124 against the bias force of spring 140 which urges plate 160 downward toward flexible stoppers 183. Before installation on the metal decking, either the upper end 181 of nose-piece or the flexible stoppers 183 prevent further downward movement of plate 160 caused by the urging of spring 140.

In use, a lead end 186 of nose-piece 180 is inserted into the metal decking installation opening 172 (see FIG. 3C) until a lower surface of flexible stoppers 183 engage the hole. Anchor assembly 100 is then urged further through opening 172 of metal decking 170, overcoming the natural bias force of flexible stoppers 180 which flex radially inward. Flexible stoppers 183 flex inward until their outer radius is smaller than opening 172, they pass through opening 172, and they flex back outward to a radius larger than opening 172. Thereafter, flexible stoppers 183 prevent nose-piece 180 which is connected to anchor housing 120 from passing backward through opening 172. While flexible stoppers 183 are being urged axially through opening 172, plate 160 moves axially along shank portion 124 against a bias force of spring 140 to accommodate the axially movement of assembly 100 through opening 172. The biasing and reactionary biasing forces of spring 140 on the top surface of plate 160 and flexible stoppers 183 on the bottom surface of plate 160 respectively secure anchor assembly 100 to metal deck 170 as shown in FIGS. 1A, 3C, and 4B.

FIG. 3C specifically shows the connection between anchor housing 120 and nose piece 180. After installation into metal decking 170, an anchor member may be inserted into central passage 125 until it is axially secured within jaw assembly 127.

As mentioned above, a cast-in-place wood form assembly 200 is also disclosed herein. Assembly 200 includes an anchor housing 120 similar or the same as the anchor housing described for use with the assembly 100. Assembly 200 also includes a base housing 260 and at least one wood form fastener 240 (e.g., a nail). Base housing 260 includes an anchor space 264 defined by a wall 262 for accommodating anchor housing 120 axially inserted into space 264. Anchor space 264 may accommodate anchor housing 120 in a friction or interference fit. Base housing 260 includes a lower engagement surface 266 which may be contacted by a lower portion of anchor housing 120 when anchor assembly 200 is fit together with anchor housing 120 in the set position. Base housing 264 includes at least one passage for axially accommodating wood form fastener(s) 240. Flange 222 of anchor housing 120 extends out radially past the radial position of the wood fastener passages so that a bottom surface of flange 222 engages heads of the wood fasteners when anchor assembly 120 is forced axially into anchor space 264.

Assembly 200 is shown in FIG. 2A in a pre-set configuration and is shown in FIG. 2B in a set configuration. Engagement surface 266 may take the form of a rim. The rim may taper to minimize surface area contact with anchor housing 120 to increase pressure at the engagement interfaces. The higher pressure between engagement surface 266 and anchor housing 120 limits, minimizes, and/or discourages ingress of concrete or concrete biproducts into the central longitudinal passage and jaw assembly 127. The entire base housing 260 or engagement surface 266 may be made of a flexible material so as to better form a seal between anchor housing 120 and engagement surface 266.

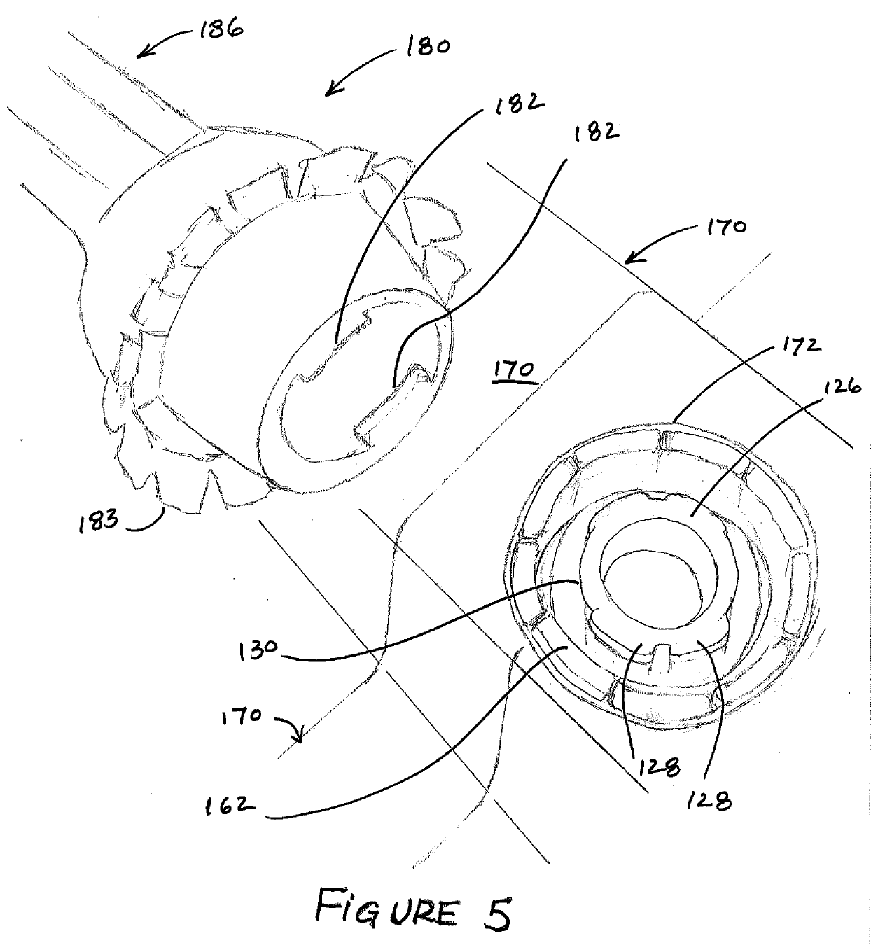

FIG. 5 shows a bottom view of a metal decking anchor assembly 100 installed in metal decking 170 with nose-piece 180 removed and laying on the side after installation. As shown in FIG. 5, removal of nose-piece 180 exposes a lower portion of nose connector 126 which is visible through opening 172 in metal decking 170. Projections 128 and voids 130 of nose connector 126 are disengaged from projections 182 of nose-piece 180. The now exposed nose-connector 126 is surrounded by a plate ring 162 which forms the lower part plate 160 and which helps position plate 161. A cast-in-place anchor assembly for anchoring objects to a concrete structure after concrete pouring and concrete setting, the objects fastened to an elongated load bearing member which is connected to the anchor assembly, the cast-in-place anchor assembly comprising:

an anchor housing, the anchor housing including an opening therein along a longitudinal axis thereof for receiving the elongate load bearing member, the anchor housing also including a jaw assembly housed in the anchor assembly, the jaw assembly for lockingly engaging and axially constraining the elongate load bearing member relative to the anchor housing,

the jaw assembly including separable jaws and the jaws including a lock structure, a bias member for biasing the jaws toward each other and a locking member for restricting movement of the jaws relative to the anchor housing.

0 relative to opening 172 before concrete curing.

1. A cast-in-place anchor system for anchoring objects to a concrete structure after concrete pouring and concrete setting, the objects fastened to an elongated load bearing member which is connected to an anchor member of the cast-in-place anchor system, the cast-in-place anchor system comprising:
an anchor housing, the anchor housing including an opening therein along a longitudinal axis thereof for receiving the elongate load bearing member, the anchor housing also including a jaw assembly for lockingly engaging and axially securing the elongate load bearing member relative to the anchor housing,
a wood anchor assembly including a base housing and at least one elongate wood fastener, the base housing including a receptacle for receiving and supporting the anchor housing, the base housing further including an opening for receiving the load bearing member, the receptacle and the opening generally aligned along the longitudinal axis,
a metal anchor assembly including a bias member, a plate, and a nose-piece, the nose-piece including an anchor connector for connecting to a nose connector of the anchor housing,
wherein, the anchor housing is connected to the wood anchor assembly or the metal anchor assembly.

2. The cast-in-place anchor system of claim 1, wherein the nose-piece further includes an opening for receiving the elongate load bearing member, the nose connector and the opening generally aligned along the longitudinal axis.

3. The cast-in-place anchor system of claim 1, wherein the anchor connector and the nose connector engage with each other as a bayonet connection.

4. The cast-in-place anchor system of claim 1, wherein the anchor connector and the nose connector engage with each other as a threaded connection.

5. The cast-in-place anchor system of claim 1, wherein the anchor connector includes nose projections and the nose connector includes anchor projections and wherein the anchor projections and nose projections engage each other to connect the nose-piece to the anchor housing and the nose-piece is selectively removeable from the anchor housing.

6. The cast-in-place anchor system of claim 5, wherein the selective removal is by twisting and axial movement of the nose-piece.

7. The cast-in-place anchor system of claim 1, wherein the jaw assembly includes threads for the locking engaging and axially securing of the elongate load bearing member.

8. The cast-in-place anchor system of claim 1, wherein the anchor housing is lockably connected to the base housing.

9. The cast-in-place anchor system of claim 8, wherein the lockable connection includes a friction fit between the base housing and the anchor.

10. A cast-in-place anchor assembly for anchoring objects to a concrete structure after concrete pouring and concrete setting, the objects fastened to an elongated load bearing member which is connected to the anchor assembly, the cast-in-place anchor assembly comprising:
an anchor housing, the anchor housing including an opening therein along a longitudinal axis thereof for receiving the elongate load bearing member, the anchor housing also including a jaw assembly for lockingly engaging and axially securing the elongate load bearing member relative to the anchor housing,
an anchor body including a bias member, a plate, and a nose-piece, the nose-piece including an anchor connector for connecting to a nose connector of the anchor housing,

11. The cast-in-place anchor system of claim 10, wherein the anchor connector and the nose connector engage with each other as a bayonet connection.

12. The cast-in-place anchor system of claim 10, wherein the anchor connector and the nose connector engage with each other as a threaded connection.

13. The cast-in-place anchor system of claim 10, wherein the anchor connector includes nose projections and the nose connector includes anchor projections and wherein the anchor projections and nose projections engage each other to connect the nose-piece to the anchor housing and the nose-piece is selectively removeable from the anchor housing.

14. The cast-in-place anchor system of claim 13, wherein the selective removal is by friction fit.

15. The cast-in-place anchor system of claim 13, wherein the anchor body further including a bias member.
